(19) United States
(12) Patent Application Publication
(10) Pub. No.: US 2026/0309208 A1
(43) Pub. Date: Oct. 8, 2026

(54) REINFORCED BELT JOINT

(71) Applicant: ECOBELT LTD, Chadderton, Oldham (GB)

(72) Inventor: Craig SPENCER-SMITH, Chadderton, Oldham (GB)

(21) Appl. No.: 19/481,422

(22) PCT Filed: Jan. 9, 2024
(86) PCT No.: PCT/GB2024/050039

§ 371 Date: Nov. 4, 2025

(30) Foreign Application Priority Data
May 5, 2023 (GB) 2306707.7

(51) Int. Cl. F16G 3/10; B29C 65/00; B29L 31/00; B65G 15/34

(52) U.S. Cl. CPC F16G 3/10; B29C 66/4324; B29C 66/7212; B65G 15/34; B29L 2031/7092

(57) ABSTRACT

There is disclosed a method of forming a joint in a belt having first and second end-edges to be joined. The method involves providing an aramid fibre section, for example as a discrete piece, having first and second edges. The first end-edge of the belt is arranged to overlap the first edge of the fibre section from one side and the second end-edge of the belt is arranged to overlap the second edge of the fibre section from the other side. The first and second end-edges are joined to the fibre section in said arrangement to form a joint interface between the first end-edge and the second end-edge, with the aramid fibre section reinforcing the joint. An adhesive may be used to bond the fibre section to the belt material. A woven aramid fibre section may be used. The fibre section may be located between plies of the belt. A variety of belts with a joint formed by the method are disclosed, including belts with spliced joints or mechanical joints.

The present application relates to a method of making a reinforced joint in a belt, particularly for conveyor belts which are prone to failure at the joint.

### INTRODUCTION

Endless belts are formed by looping a desired length of the belt material and forming a joint such that a first end of the belt material is joined to a second, opposing end. Common joining methods include vulcanised/spliced joints, butt joints and mechanical fasteners.

It is typical to join the opposing ends of a belt together as a thermally bonded splice. A common example of splicing involves cutting or punching finger-like formations in the ends of the belt and attaching the two ends together so that the fingers on each end fit between the opposing fingers on the other end. The fingers are butted and bonded, either thermally or using an adhesive. The strength of the connection is a direct result of the length and the shape of the fingers. The interface between the belt ends thus passes back and forth along the fingers such that it is longer than the width of the belt and angularly offset from the longitudinal axis of the belt. This type of joint may be referred to as a ‘Z splice’ or ‘finger splice’. The joint may be subjected to temperature, pressure and/or an adhesive.

Where the belt material comprises a plurality of plies, the finger formations for different plies may be offset so that the joint interface for one ply is laterally and/or longitudinally offset from the interface of a different ply. This may be referred to as a ‘stepped Z splice’ or ‘finger over finger splice’.

A mechanical joint uses fasteners such as clips, staples or spiral lacing to mechanically attach the two opposing ends of the belt together. The strength of the connection is dependent upon the frequency and the nature of perforations made by the fasteners into the material. However, a limitation of this method is that certain fasteners can only be applied to certain types of belts because of the limited belt thickness range that can be accommodated by a specific type of fastener. The interface represents a discontinuity in the belt and the presence of the mechanical fasteners may in themselves be problematic for the smooth/continuous belt running.

From the above discussion, it can be appreciated that significant attention is given to the joint in order to ensure it is suitable for the intended use of the belt. However, regardless of the method employed; the joint is invariably a potential point of weakness of the belt and is the mostly likely point of failure over the operational belt life.

The tensile strength of the joint is a particular problem for endless PVC or PU conveyor belts where contaminants build-up and become embedded in the belt and on the rollers. The increased volume increases the roller's diameter which puts the belt in greater tension and eventually causes failure, usually at a joint. Another example of belt failure under tension arises when the belt tracking is misaligned, meaning the one lateral side of the belt is put under greater tension than the other, often in a cyclic manner.

However the tensile strength of the joint represents only one engineering consideration. There are a wide variety of belt failure modes including delamination, e.g. peeling of one or more ply at the joint, and belt puncture. In many cases, a small initial defect at the joint will grow over time by propagating along the joint interface.

It is estimated that approximately 85% of belt failures in industry occur at the joint. In some instances the belt is repaired but the cost of the repair, and the likelihood of a subsequent failure of the belt arising, means that it is often more cost effective to fit a new belt.

For production and distribution facilities, the key operational consideration is typically the downtime of a line caused by belt failure. For this reason, replacement belts are often held on site and belt suppliers are conventionally judged on the speed with which they can be available to replace a belt.

The status quo therefore means that an overwhelming majority of belts do not reach their natural end of life due to wearing of the belt material itself but are rather thrown away and replaced early with a new belt due to a failure of the joint.

Furthermore, conveyor belts are typically made from thermally bonded and unrecyclable PVC or PU materials causing environmental waste which is sent to landfill. This is a particular problem for fulfilment centres which can have many miles of conveyor belts running through a centre at any one time.

When looking for more environmentally sustainable solutions there is a clear need to address the problem of discarded belts. Whilst so-called endless belts are known, their method of manufacture results in a belt that is many times the cost of joined belts of the types described above.

It is the aim of the present invention to mitigate or eliminate one or more of the above problems.

### STATEMENTS OF INVENTION

According a first aspect of the invention there is a method of forming a reinforced joint in a belt having first and second ends to be joined, the method comprising: providing a fibre material section having first and second opposing edges such that the first end of the belt at least partially overlaps the first edge of the fibre material section, and the second end of the belt at least partially overlaps the second edge of the fibre material section; and joining the first and second ends to the fibre material section to form an interface between the first and second ends such that the fibre material section spans the interface.

According to a second aspect of the invention there is method of forming a reinforced joint in a belt, the belt extending in a longitudinal direction and comprising first and second ends which are to be joined at an interface, a discrete fibre section being inserted at the interface and extending in the longitudinal direction, the first and second ends being joined to the fibre section.

According to a third aspect of the invention there is a method of forming a reinforced joint in a belt, the belt extending in a longitudinal direction and comprising first and second ends that are to be joined at an interface, a fibre section being inserted at the interface, the first and/or second ends being joined to the fibre section, where the length of the fibre section is configured so as to extend a predetermined distance from the interface in a longitudinal direction from both the first and second ends.

According to a fourth aspect of the invention there is a method for forming reinforced joint in a belt are defined in claim 1.

According to further aspects of the invention there is provided a belt or conveyor belt resulting from the method of any of the first, second or third aspects.

The resulting belt and associated method may create a reinforced joint or interface region that has greater strength than the remainder of the belt. Specifically, ensuring that fibres run through the interface means there is continuity between the first and second ends of the belt (e.g. end-edges thereof). The fibres provide a force-path between the two ends to be joined.

The fibre section may span the interface. The fibre section typically terminates either side of the interface such that the discrete fibre section is not present throughout a remainder of the belt.

The fibre section may be present on either or both sides of the interface, e.g. in the direction of first end and/or second end.

The fibre section may be continuous through the interface. The fibre section may span the interface.

According to another aspect of the invention there is a belt, comprising a reinforced fibre section at a joint in the belt, where the reinforced fibre section is joined proximal to an end of the belt forming one side of the joint, the fibre section having a discreate length in a longitudinal direction and the belt is longer in the longitudinal direction than the fibre section.

According to a further aspect, there is provided a belt having a reinforced joint, the belt extending in a longitudinal direction and comprising first and second end edges that are joined at an interface to form a loop, wherein the belt comprises a fibre layer at the interface, the fibre layer being continuous through the interface such that it passes continuously from the first end edge through the second end edge and terminates at a location spaced from the interface in the longitudinal direction of the belt, whereby the continuous fibre section running through the interface reinforces the joint.

The fibre layer may be referred to herein as a fibre section.

At least some fibres of the fibre layer/section may be oriented in a direction that is offset from the longitudinal direction of the belt. At least some fibres may be oriented in the lateral direction of the belt and/or obliquely (e.g. angularly offset from both the longitudinal and lateral directions. The fibre layer/section may comprise both warp and weft fibres, e.g. as a woven textile layer/section.

The reinforced joint may provide a stronger, more robust joint than those of the prior art. The joint may be less prone to failure and/or may withstand higher tensile loads. The fibre reinforced section of the belt, i.e. in the vicinity of the joint, may have greater tensile strength and/or puncture resistance than a remainder of the belt.

The reinforced joint may increase the service and operational life of the belt, e.g. meaning machine and operational downtime due to belt failure is reduced.

Increasing the operational life of the belt may mean that belt wastage is reduced.

The fibre section may be generally planar. The fibre section may comprise a body portion, which may be flat. The fibre section (e.g. the body portion thereof) may comprise first and second edges which oppose each other, and may further have intermediate/side edges that extend between the first and second edges. The fibre section (e.g. the body portion thereof) may be quadrilateral in shape, for example square, rectangular or parallelogram in shape.

The fibre section may comprise a mat or web.

The fibre section may comprise a composite structure. The fibre section may comprise fibres in a matrix. The fibre section may comprise a fibre layer and one or more further layer, e.g. above and/or below the fibre layer. The further layer may comprise a support layer, substrate or bonding layer. The fibre section may be provided in the form of a piece or patch, e.g. with the fibre layer provided on a substrate layer.

The fibre section (e.g. the body portion thereof) may have substantially the same width or lateral dimension as the belt (e.g. the first or second end edges thereof) or belt body. The fibre section may span the lateral dimension of the belt, e.g. between opposing lateral sides of the belt. The fibre section may not protrude beyond the lateral sides of the belt. In some examples, the fibre section may be narrower in width than the belt.

The fibre section (e.g., the body portion thereof) may or may not have a longer width or lateral belt dimension than its length or longitudinal belt dimension. Hence the fibre section may substantially extend across the interface between the first and second end-edges when inserted.

A dimension of the fibre section in the longitudinal direction of the belt may be significantly less than the belt length, e.g. at least one or two orders of magnitude shorter. The fibre section may only be a few centimetres in length relative a belt that is at least metres or tens of metres long. The fibre section may extend beyond the interface by less than 10 cm or 5 cm in the longitudinal direction, e.g. by less than 3 cm or 2 cm. The fibre section may substantially match the longitudinal dimension of the interface.

The interface may be defined to be the line, area or volume between the opposing end-edges of the belt. The interface may be defined to be the join or line/area of contact between the first and second end-edges. The interface may have a visible seam where the first and second end-edges interfere or overlap with one another. The interface may overlie the fibre section, e.g. meaning that the interface is contained within the area, footprint or perimeter of the fibre section (e.g. of the first and/or second major faces of the body portion) when viewed in plan.. Parts of the seam and/or interface may extend beyond over the first or second edges.

The first and second ends of the belt may be joined to each other, as well as to the fibre section.

The interface (e.g. the seam thereof) between the first and second end-edges may follow a path/axis substantially perpendicular to the longitudinal direction of the belt. Alternatively, the path/axis of the interface may be angled, e.g. obliquely angled, with respect to the longitudinal axis, e.g. where the interface appears to be running diagonally through the belt width.

The interface may follow a tortuous path through the width of the belt. The end-edges may be profiled/cut define opposing formations or protrusions in the first and second end-edges. The opposing formations may be interlocked or interposed at the interface. The formations may comprise fingers/wedges (e.g. spliced formations).

The belt may have first and second major/opposing faces (e.g. upper and lower faces). The fibre section may be located between the first and second faces of the belt, e.g. within the depth or material thickness of the belt. In some embodiments a recess or groove can be formed in the depth of the belt proximal to the end-edge of the first and/or second ends, e.g. such as to accommodate the depth of the fibre section within the depth of the belt. For example, the depth of the recess may correspond (or be the same) as the thickness/depth of the fibre section. This may help to avoid the fibre section increasing the belt depth significantly in the vicinity of the interface.

The interface may have a zig-zag appearance. The interface may follow a path that varies relative to the interface axis, e.g. oscillates or zig-zags back and forth relative to the interface axis.

The fibre section (e.g., the body portion thereof) is discrete or discontinuous piece (e.g. terminating part way or a short distance along the length of the belt from the interface) such that it does not extend throughout the longitudinal length of the belt. The fibre section is located proximal to the interface. The fibre section may extend partially in the direction of the first and/or second end-edges or beyond the first and/or second end-edges in the longitudinal direction. In some embodiments the fibre section may be located continuously or substantially continuously through the belt and/or be integrally formed into the belt.

The first end and/or second end may comprise a plurality of layers or plies. The fibre section may be inserted in-between said plies or layers.

The method may comprise forming or separating the plurality of plies in the first and/or second end of the belt. The method may comprise splitting the belt in its depth dimension part way between the upper and lower surface of the belt. The methos may comprise splitting the first and/or second end or separating plies in the first and/or second end only for a predetermined/limited length of the belt in the vicinity of said end.

In some embodiments, plies or layers of the belt are partially separated at the end-edges for inserting or attaching the fibre section; a majority or mid section of the belt length may not be separated. The fibre section may not extend into the middle section of the belt. Where the belt is formed into an endless belt, the fibre section is not endless, e.g., the first and second edges of the fibre section are not joined as a loop.

Having the fibre section proximal or close to the joint reinforces the weakest part of the belt, and reduces weight, complexity, and cost of manufacture by not having to reinforce all of the belt.

One or more fibre section may be inserted between the one or more plies and the end-edges may then be cut to form the desired formations/profile in the end edges (i.e. the interface when joined). The first and second end-edges engage with the fibre section and/or other end-edge and are joined to the fibre section.

The fibre section may be fused, bonded or adhered to the first and/or second end of the belt. The fibres or fibre layer may be bonded using an adhesive/glue. The fibre section may comprise an adhesive layer.

Heat and/or pressure may be applied to the fibre section in situ with the first and/or second end of the belt. An adhesive may be melted between the fibres and the belt to bond the fibre section to the material of the belt. A continuous adhesive layer may be provided over the area of the fibre section. The fibres may be sandwiched between a pair of adhesive layers.

A predetermined elevated temperature and/or pressure may be maintained for treatment/formation of the joint, e.g. for a predetermined time. The opposing eds of the belt and the fibre reinforcement may be held in a press.

The treatment may comprise heating the belt between 80-250° C.; optionally between 120-200° C.; optionally between 150-170° C.

The heat/pressure treatment may be applied for up to 1 hour; optionally up to 30 mins; optionally up to 10 mins; optionally up to 5 mins; optionally up to 2 mins; optionally up to 1 min. The treatment may be at least up to 1 min; optionally at least 2 mins; optionally at least 5 mins; optionally at least 10 mins; optionally at least 30 mins; optionally at least to 60 min. The listed durations may instead be used to form appropriate ranges for the duration for which the treatment time is to last (e.g., between 10-30 mins).

The treatment pressure may be at least 0.1 bar, for example at least 0.2 bar, 0.5 bar, 1 bar, 2 bar, 5 bar, or at least 10 bar; optionally at least 20 bar. The treatment pressure may be less than or equal to 20 bar or 10 bar, for example less than or equal to 8bar, 5 bar, 2 bar, 1 bar, 0.5 bar or 0.2 bar. The listed pressures may instead be used to form appropriate ranges for the pressure (e.g., between 0.1-10 bar or 2-5 bar).

The fibre section may comprise fibres capable of withstanding high tensile loads. The fibre section may comprise para-aramid fibres such as Kevlar (registered trade mark). The fibres may comprise other types of aramid fibres such as meta-aramids. The fibre section may comprise carbon fibres, nylon, glass or graphene fibres. The fibre section may comprise a mixture/blend of different combinations of fibres.

The fibres may be provided in the form of a textile layer, such as a mat, web, net or mesh. The fibres may be interlaced, knitted or woven or applied to a foil/support layer. The textile layer may be an open textile layer, e.g. having openings/apertures between fibres or bundles of fibres (which may be suitable for acting as key locations discussed below).

The fibres may be arranged in a regular pattern. Bundles of fibres may be arranged in a regular pattern. The fibre layer of the fibre section may have apertures, e.g. as an open weave/pattern, or may comprise a close or tight weave/pattern. The fibres may be arranged in an irregular or random configuration. The fibre layer may have a mesh like appearance such that it is partially see-through.

The fibre layer (i.e. fibres) or the body portion may be woven to form a weave, for example into an open or closed-weave. The open weave will be understood to mean that there are a number of apertures in in the weave. The weave may be defined by porosity i.e. percentage/ratio of fibres to gaps (with reference to major surface).

The textile may have a porosity of more than 95%, or more than 90%, or more than 85%, or more than 80%, or more than 75%, or more than 70%, or more than 65%, or more than 60%, or more than 55%, or more than 50%, or more than 45%, or more than 40%, or more than 35%, or more than 30%, or more than 25%, or more than 20%, or more than 15%, or more than 10%; where a lower porosity corresponds to a denser/more closely packed weave. Any textile pattern with a porosity less than 10% may be defined as a closed-weave. The type of weave, for example the porosity of the weave, may depend on the type of belt and/or purpose of the belt. For example, a lower porosity weave may have a higher tensile strength than another more porous weave made from the same material and will be better suited for belts under higher tensions.

The weave may be a plain weave, or satin weave, or twill weave, or leno weave.

The fibres may substantially extend in two or more directions in the textile layer. Some fibres may extend in the direction substantially parallel to the longitudinal axis of the belt, e.g. one of the warp or weft of a woven textile. Some fibres may extend in a direction substantially perpendicular to the longitudinal axis of the belt. Additionally or alternatively the fibre section may comprise fibres that are substantially angled to the longitudinal axis of the belt, i.e. between 1-45 degrees. Optionally, the fibre section has fibres which extend in a first angled direction and a second angled direction, perpendicular to the first.

The fibres may be provided in an adhesive matrix, e.g. coated in adhesive. The fibres may be partially or fully saturated in the adhesive. The fibre section may comprise an adhesive coating, such that the textile layer is at least partially coated in the top and/or bottom surface. The coating may substantially envelope the textile layer or fibres therein The adhesive may be capable of being cured once or plurality of times, for example, two or more times. For example, the adhesive may be reusable such to become at least partially vicious after curing or hardening. The adhesive may be a thermoplastic, capable of being reset. Where the belt is comprised from PVC or PU material, the adhesive is configured to bond the fibres to the PVC or PU material of the belt.

The adhesive may be flexible once cured or hardened. In use, a conveyor belt will bend for example, when moving around rollers. The adhesive may be configured to allow for some flexibility without compromising the joint. For example, the adhesive may not be rigid and/or brittle.

References in this application to the adhesive of the fibre section ‘curing’ or being ‘cured should be understood to mean that the adhesive has first and second states, where the first state is harder or more viscous than the second state. In some embodiments, the first state may mean the adhesive is solid and the second state is fluid; however, in some embodiments both the first and second states may both be fluids where the first state is more viscous than the second state.

. The coating may pass through one or more apertures in the body portion. The adhesive is capable of bonding the fibres of the body portion to the belt (e.g., the first and/or second end-edges thereof).

The apertures may define ‘keying locations’ whereby the belt material can penetrate through the body portion of the fibre section. The number of keying locations may depend on the structure of the fibres of the body portion, e.g., the weave or porosity of the weave,. The greater the porosity of the weave, i.e. the more open the weave, the more key locations may be available for the belt material to penetrate the fibre section from above/below. For example, an open-weave may have more apertures than a closed-weave. Where the fibres of the body portion are non-woven, the key locations are the gaps between adjacent fibres or fibre bundles. In some embodiments, key locations can be added by puncturing the body portion, this is particularly beneficial for (but not limited to) closed-weaves which by nature do not have many apertures/key locations.

In some embodiment the fibres may be 3D-printed, and may be printed directly into a desired pattern/weave.

The fibres of the fibre section may be in a raw-loom state, for example, before being covered in with the adhesive. Using raw-loom fibres, i.e. untreated fibres, may improve the adhesion properties of the fibres, e.g. forming a stronger bond to the adhesive.

The belt may be comprised of multiple sections which are joint together (i.e. using one or more reinforced joints). This is particularly beneficial for forming longer belts. By using multiple reinforced joints, the complexity and cost of making belts can be reduced when compared to making specialist longer belts.

The belt may be comprised from a Polyvinyl Chloride (PVC) and/or Polyurethane (PU) material. The belt (e.g., belt body) may have a longitudinal axis or direction in which the belt may extend or elongate. The belt is considerably longer than the fibre section such that the fibre section does not extend through the belt body.

The belt may be an endless belt such as a conveyor or timing belt.

The belt may have an unfurled length (e.g., when the belt is not formed into an endless belt) of 1 m, 2 m, 5 m or more, e.g. 10 m or more, 20 m or more, or 50 m or more.

The belt width may be 5 cm or more, e.g. at least 10 cm, 20 cm, 30 cm, or 50 cm in width. The belt width could be up to or more than 1 m or 2 m.

The reinforced joint may comprise mechanical fasteners joining the first end-edge to the second end-edge. The fasteners may comprise staples, clips, pins, eyelets or a combination thereof.

The reinforced joint may be able to withstand tensile loads equal to or greater than 2,500 N, 2,750 N, or 3,000 N. The reinforced joint may have a tensile strength of greater than or equal to 50 N/mm, 55 N/mm or 60 N/mm. In some examples, the tensile strength is at least 70 N/mm or 80 N/mm The reinforced joint may have improved puncture resistance relative to an non-reinforced joint. The reinforced joint may withstand a puncture force of at least 600 N, 700 N, 800 N, 900 N or 1,000 N. The reinforced joint may offer compressive stress of at least 10 MPa, 15 MPa or 20 MPa. The puncture resistance of the reinforced joint may be greater than that of the mid portion of the belt, i.e. spaced form the joint.

According to another aspect of the invention there is method of forming a reinforced joint in a belt, the belt comprising a first end extending in a longitudinal axis, the first end being joined to a fibre section of discrete length, where the belt and fibre section partially overlap at the first end by a predetermined distance.

The first end or second end of the belt may be defined as an end-edge. The belt may have two longitudinal edges, i.e. sides, which are substantially parallel to the longitudinal axis. The first end-edge and/or second end-edge may extend between the longitudinal edges. The first end edge and/or second end-edge may extend perpendicularly to the longitudinal axis or else at an oblique angel thereto.

A first fibre section may be provided at the first end edge. A second fibre section may be provide at the second end edge. Mechanical fasteners may pass from the first end edge to the second end edge. The mechanical fasteners may extend or puncture through the first and/or second fibre section.

According to another aspect of the invention there is a sheet material for use in forming a reinforced belt joint said sheet material comprising a fibre composite layer comprising a textile comprising aramid fibres provided in an adhesive matrix; where the adhesive at least partially covers the aramid fibres and is cured.

The fibre composite layer may be provided on a support/substrate, e.g. a support/substrate layer or film/foil, on either or both sides of the textile layer.

According to another aspect of the invention there is a method for forming a fibre section for use in reinforcing a belt joint.

Any of the optional or essential features defined in relation to any one aspect of the invention above may be applied to any further aspect, wherever practicable. Those optional feature combinations have not been explicitly repeated only for conciseness.

References to fibres herein may also ne references to bundles of fibres, such as yarns. Workable embodiments of the invention are described in further detail below, by way of example only, with reference to the accompanying drawings, of which:

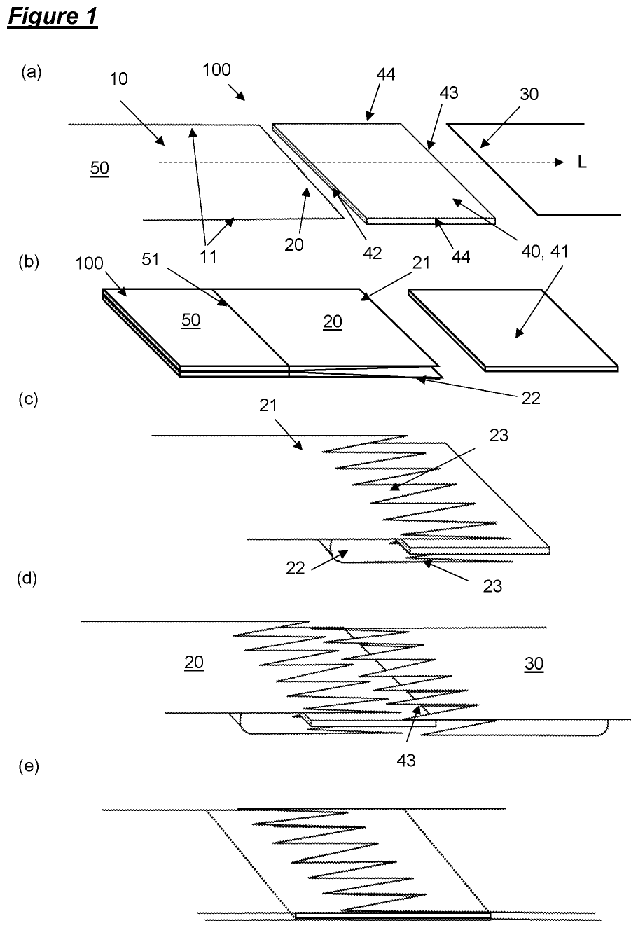

FIGS. 1(a) to (e) show schematic three-dimensional views of stages of a process of forming a joint in a belt.

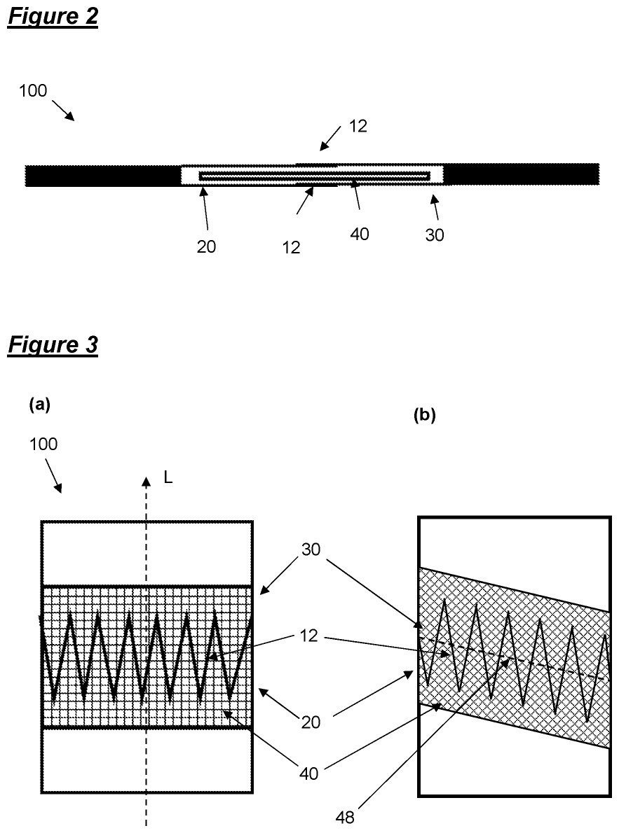

FIG. 2 shows a schematic longitudinal sectional view through a joint.

FIG. 3(a) and (b) shows schematic plan views of example joints.

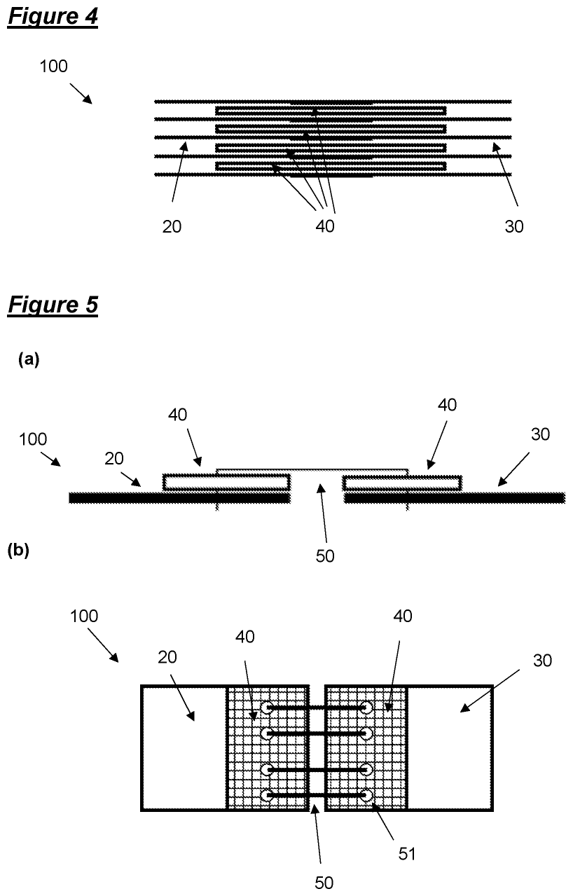

FIG. 4 shows an alternative arrangement of a joint in longitudinal section.

FIG. 5(a) and (b) show respective sectional and plan views of an alternative arrangement of a reinforced joint.

### DETAILED DESCRIPTION

The invention may be applied to any belts of conventional construction, typically comprising a belt core layer comprising a fabric/textile material provided with a top face layer and underside layer according to the intended use of the belt. The belt body is generally flat, although profiled belts could be considered. The belt body typically has a width dimension that is significantly greater than the material thickness of the belt and a length dimension that is significantly greater than the width dimension, e.g. with the width being at least an order of magnitude greater than the thickness and/or the length often being an order of magnitude or more greater than the width. However the specific belt dimensions depend on the intended belt use and belts may be made shorter/longer, narrower/wider and with varying thickness according to its use requirements.

The textile material in the core of the belt may be selected to suit a variety of requirements, including belt tracking properties, load/elongation properties, electrostatic properties, flatness, knife edge and curve suitability. In some examples, a monolithic or single ply belt may be used, whilst in many examples the belt will have a plurality of plies. Conveyor belts are used for a wide variety of applications to support and move objects or materials between points. Depending on the intended application, conveyor belts may have bespoke formations on their underside, e.g. tracking guides; their upper side, e.g. flights; and/or at their lateral edges, e.g. sidewalls. Any and all such modifications to plain belts may be accommodated by the present invention provided the belt ends are required to be joined to form a closed loop for its intended use. The invention concerns the method of forming a belt joint, the reinforcement material used for the joint and the resulting belt joint.

The invention is described initially in relation to the figures with respect to a belt with two or more plies.

The process for joining opposing end-edges of a belt together is now described.

In the first embodiment of the invention with reference to FIG. 1, the joint 100 comprises a first 20 and second 30 end-edges of a belt 10 which are joined to a reinforced fibre section 40. The first and second ends of the belt define an interface at the region where they engage (for example, overlap). The interface may be described as a seam between the ends 20, 30.

The fibre section 40 comprises a body portion 41 comprised of woven para-aramid fibres which can resist high tensile loads, are tear resistant and have excellent fatigue properties when compared to other regions of the belt. The properties of para-aramids fibres make them an ideal choice for reinforcing the joint. They have a tensile a strength five times greater than steel (when compared weight for weight). They are also lightweight and highly flexible which is important for endless belts as they wrap and bend around rollers. Para-aramid also has good fatigue properties, particularly flex-resistance which is again important as the loads on the joint are subject to change as it passes around the conveyor. Para-aramid is also tear resistant, meaning that a tear/rip in the joint is less likely to propagate. Furthermore, para-aramids can be woven and styled into many different weaves or other textile patterns.

The body portion is coated in an adhesive which is configured for joining the body portion 41 to the belt (e.g., the composition of the adhesive is chosen based on the materials of the belt and fibre section). Where the belt is a conveyor belt made from PVC or PU, a suitable adhesive is rubber cement such as Rima Tiptop C4 Cement (RTM); however, the specific adhesive used will be dependent on both the type of fibres on the fibre section and the material of the belt.

Different adhesives for bonding the fibres of the fibre section to the belt material have been considered. The adhesive may comprise one or more of Polyvinyl acetate (PVA), Polyvinyl alcohol (PVOH), Polyacrylates, Polyester acrylics, Acrylic solvent cement, or rubber cement (such as Rima Tiptop C4 Cement (RTM)). Where the fibres comprise aramid, the adhesive may be any material capable of bonding/joining/attaching aramid to belt material. It is understood that the skilled person could routinely attempt different adhesives according to the particular fibre material or blend of fibres selected, as well as the belt material.

To make a fibre section, the body portion comprises an arrangement of woven and/or non-woven fibres that are first coated/treated in the adhesive. In this regard, fibres, such as aramid fibres are awkward to cut/handle when in an untreated, loom state.

The adhesive is left to dry, harden or cure by methods which will be known to the skilled person, e.g. UV curing, heating or allowing to rest in ambient conditions.

The fibre section may be treated/coated on a surface with a non-stick coating such as Teflon (RTM) to prevent the adhesive bonding to the surface on which the fibre section is being worked.

The adhesive makes the fibre section easier to work, for example to cut and position in place in/on the belt. The adhesive keeps the fibres aligned correctly and helps prevent the fibres creasing making it easier to cut. The fibre section comprising the body portion and cured adhesive can be cut, for example to form a plurality of fibre sections 40 from a larger fibre section or else to cut/shape the edges for fitment with a specific belt profile.

The fibre section 40 is generally quadrilateral/rectangular has first 42 and second 43 opposing edges which are separated by side edges 44. The first and second edges correspond to the width of the belt 10. The length of the side edges 44 corresponds to the extent of the interface between the belt end-edges 20, 30.

The fibre section 40 is coated with the adhesive to ensure all areas of the fibre textile are fully covered/saturated with the adhesive. In prototype applications, fibre sections were coated by hand using a brush. The non-stick support surface ensures the adhesive is deflected from the surface back onto the body portion and prevents the adhesive containing the fibre section from bonding to the surface. In practical applications of the technology for production of the fibre section, different coating methods would typically be used, such as roll coating, dip coating, spraying, etc. In particular, it is envisaged to use a coating process in which the textile of the fibre section is passed around a roller submerged in a tank of adhesive so that the fibre section picks up the adhesive as it passes around the roller. Various industrial textile coating process could be considered to produce the desired composite fibre section material.

The adhesive is left to dry/cure in an ambient environment such that it hardens making it easier to handle and work. Once dried, the fibre section 40 can be cut to size, e.g., into strips. The desired shape which may be determined by the dimensions of the belt 10.

In FIG. 1, the shape fibre section 40 is rectangular, where the longest width edge 42, 43 corresponds to the width of the belt; however, the width of the fibre section may be slightly shorter such that it does not protrude from the side edges 11 of the belt 10.

The fibre section 40 may be produced in batches or continuously to decrease production time and improve scalability. In this case, a plurality of fibre sections 40 can be cut from a larger/longer section of material.

FIG. 1a-e shows a first embodiment of the invention. The figure shows various stages of joining a belt 10 to a reinforced fibre section 40 so as to form a belt loop. Part (a) shows first 20 and second 30 end-edges of belt 10 and a fibre section 40. The belt 10 comprises a belt body that extends in a longitudinal direction L.

A middle section 50 of the belt 10 separates the first 20 and second 30 end-edges. Only a portion of the middle section 50 is shown and the middle section would in fact loop round between the first 20 and second 30 end-edges such that those ends are joined by the continuous belt body.

The belt body 10 is comprised of plies which are bonded together. Although there can be multiple layers, the embodiment shown only contains two plies only. The belt could comprise, for example, any of a conventional PVC, PU or Silicone belt.

In part (b) the plies of the belt 10 have been separated along the first end-edge 20 up to the middle section 50 defining top 21 and bottom 22 plies. The middle section 50 can be defined as the region where the plies/layers are not separated. A line 51 has been provided as a reference to show where the transition occurs between the middle section 50 and first end-edge 20.

When splitting plies 21, 22 a knife or similarly sharp tool may be inserted into or along the end-edge 20 initially to separate the layers. The plies 21, 22 may then be pulled/prised apart up to the desired separated length in the longitudinal direction, L. This may be achieved in conjunction with pressure/agitation of the knife. In some examples, a wire or similar could be used in place of a knife/blade.

The second end-edge 30 is split apart in a similar manner. The present embodiment allows splitting or parting of the belt at the interface between existing plies. In examples where the belt is a monolithic structure, rather than layered structure, it is possible to cut into the monolithic structure at a predetermined height to create a split end section for the purpose of the present invention. This may therefore create partial plies akin to the arrangement shown in FIG. 1(b).

In part (c), fingers 23 are punched into the top 21 and bottom 22 ply layers by methods which will be known to the skilled person. The fingers 23 are substantially wedge shaped, each being triangular and extending from a base to a distal point or apex. The fingers 23 may extend partially in the first end-edge 20 such that there is a gap between the base of the fingers 23 and the transition line between the middle section 50 and first end-edge 20. Alternatively, the splice (i.e., the finger cut) may fully extend up to the transition line 51.

The position of the splice cut may be different from on the top 21 and bottom 22 surfaces such that fingers 23 extend at different lengths. For example, the fingers 23 on the bottom ply layer 22 may extend further than those of the top 23 or vice versa. The splice may be configured to cut the first end-edge 20 such that when bonded to the fibre section 40, the edge is located fully over the body portion 41, i.e., the edge does not protrude over the first edge 42 of the body portion 41. However, in some embodiments part of the cut may extend over the first edge 41.

The punching/cutting process is repeated for the second end-edge 30 as shown in part (d) from the opposite side such as to extend over the second edge 43 of the fibre section 40.

The splice cut can instead be punched into both the end-edges at the same time.

FIG. 1 shows only one example of formations for splicing the opposing end-edges of the belt 10 together. It will be appreciated that the ends could be devoid of such formations, and the end-edges 20, 30 may simply abut one another to form the joint. Alternative splicing formations could also be used as desired.

It is generally desirable to cut the formations/fingers 23 after the plies 21, 22 have been separated. This makes the ply separation process simpler to achieve. Also, in this way, individual plies can be cut/punched separately to provide different or offset formations if desired. Alternatively, the separated plies can be held together and cut collectively. Both ends could be held together and cut with a common tool, if desired.

The fibre section 40 is located between the top 21 and bottom 22 ply layers, either with or without the formations 23 having been formed.

The separated plies of the first end-edge 20 of the belt are located over the opposing major surfaces of the fibre section 40 (i.e. above and beneath the fire section. The separated plies of the second end-edge 30 are then located over the fibre section in the same way as the first end-edge but from the opposing direction. The fingers of the first and second end-edges are located over the fibre section in an alternated or interfering fashion such that when joined, the first end-edge fingers engage between the second end-edge fingers and vice-versa. This forms the Z-splice arrangement of FIG. 1(e) ready to be joined.

As well as the adhesive coating of the fibre section 40, additional adhesive may be applied at the interface/seam between the opposing end-edges to bond them together, along with the bond formed with the fibre section 40.

In some examples, there may be a plurality of fibre sections inserted between different plies of the belt ends such to define a fibre section stack. In this way, more than one fibre section could be used in order to increase the reinforcement of the joint. The uppermost ply defines the first major surface of the belt in use and may overlay the fibre section (i.e., the first major surface of the fibre section). The bottommost ply defines the second major surface of the belt in use and may overlay the fibre section (i.e., the second major surface of the fibre section).

FIG. 1(e) shows the joint during/after being treated. Heat and pressure is applied to melt the adhesive of the fibre section and such that it bonds/fuses to the belt material, e.g. such as the PVC/PU material of the belt body. A heated press can be used to this end. Treatment temperatures in the range 120-200° C. have been found to be practical. An applied pressure of between 0.1-10 bar has also been trailed and found to be practical depending on the material combinations used. Pressure is ideally applied evenly over the joint region.

The duration of heat/pressure treatment to form a desirable joint could be up to 10 mins. However, it is found that elevated temperature and pressure for various adhesive, fibre and belt materials could be far lower, e.g. less than 1 minute, whilst still providing a suitably bonded joint. Also, it will be appreciated by the skilled person that the materials used, thickness of the belt, number of plies and/or number of reinforcing sections may all affect optimal press settings and the associated duration.

An interface forms where the first end-edge abuts, engages or is immediately adjacent the second end-edge. The interface may appear like a seam on the finished product.

The fibre section is discontinuous such that it only extends partly into the belt body, i.e. of both the first and second end-edges, in the direction of the longitudinal axis, L. Preferably, the fibres section extends beyond the longitudinal length of the interface. This ensures the plies of opposing ends 20, 30 are fully supported right to the extremity of the interface, e.g. the tips of the splice formations 23, which can represent a conventional point of weakness in the belt joint. The fibre section extends only a predetermined length beyond the extent of the interface in the longitudinal direction, such as 10 cm, 5 cm, 3 cm or less. The extent of the fibre section may be equal on both sides of the interface, e.g. in an upstream and downstream direction relative to the longitudinal direction of travel of the belt in use.

The interface may be contained entirely within the footprint or plan area of the fibre section.

The first and second end-edges may be part of the same belt body, where the belt body is curved/folded over such as to form an endless belt. Such a belt would therefore have a single reinforced joint. Alternatively, the first and second end-edges may be part of two adjacent belt bodies which are to be joined. In this way, any desired length of belt could be achieved by bonding a plurality of belt bodies together. The belt would then have a plurality of the reinforcement joints at different points along its overall length.

FIG. 2 shows a schematical sectional side view of the reinforced joint 100. The top and bottom plies/layers extend over and under the fibre section 40 and are joined to the fibre section. Where the first and second end-edges meet or overlap defines an interface 12. A seam is visible when the belt is viewed from above and below.

FIG. 3a shows a schematic view of the first embodiment where the fibre section has been made visible through the formed belt joint/interface 12. The seam of the interface 12 can be seen to be substantially located over the major surface of the fibre section 40. In this example, the axis of the interface 12 is perpendicular to the longitudinal axis L and the path followed by the interface zig-zigs back and forth about the interface axis.

The direction of the fibres in the fibre section 40 is shown schematically as being akin got a mesh or grid in which the warp and weft are arranged perpendicular and horizontal to the longitudinal axis L. The alignment of the fibres in the fibre textile mat is thus obliquely offset form the path if the interface 12. The alignment of fibres relative to the longitudinal axis L may be useful in preventing any give in the fibre section 40 in the direction of applied tension in use. That is to say the fibre section is inextensible in the longitudinal direction L.

In various other examples, the interface axis and alignment of the fibres in the fibre section could be varied independently or collectively, relative to the longitudinal axis L. In FIG. 3(b) there is shown an interface axis 48, which is obliquely angled relative to the longitudinal axis of the belt. In this example, the fibre section 40 could be rectangular or could be parallelogram in form to follow the direction of the interface axis 48. The lateral edges of the fibre section 40 may thus also be obliquely angled relative to the longitudinal axis.

Also in FIG. 3(b), the angle of the warp and weft of the fibre section 40 is offset from the longitudinal axis, e.g. by 45°.

FIG. 4 shows an alternative embodiment of the invention where the first and second end-edges of the belt comprise multiple layers of ply which are separated, and a fibre section being inserted between each layer. The fibre section stack produces a strong joint once treated which is better able to resist high tensile loads.

In other examples, a fibre section 40 could be placed over the exterior surface of the belt 10, i.e. on the upper surface and/or the underside of the belt, to cover the interface 12 or the associated seam. Such an arrangement could be used in addition to a single internal fibre section 40 between the plies of the belt or in addition to a stack of fibre sections.

In some examples, the fibre section on the exterior surface(s) of the belt could be used instead of the fibre section 40 between the plies. This may be particularly useful for example when repairing existing belts by strengthening an existing interface. The fibre section 40 in such examples may be provided with one or more outer layer so as to comprise a layered composite structure. The one or more outer layer may provide a cover layer for the fibre section to either fuse to the belt surface or else cover the fibre layer when it is attached in situ to the belt. Any of the features discussed herein concerning the alignment of the fibre section relative to the interface may also apply to a fibre section applied to the belt exterior surface. A pair of external fibre sections may sandwich the belt (i.e. the belt interface region).

### Various Options for Further Embodiments

FIG. 5a-b shows a further embodiment of the invention. Both the first and second end-edges are joined to separate fibre sections 40. The fibre sections 40 may be between plies of the belt ends or else bonded to the belt exterior as discussed above. The edge of the first and second edge-edges is substantially aligned to an edge of the fibre section. In the embodiment, the fibre section overlays the first and second ends and is joined using the methods described above.

As shown in 5b, the fibre sections and belt (i.e., edge-edges) comprise a plurality of apertures 51 which allow mechanical fasteners 50 to be inserted such that the first end-edge 20 can be linked to the second end-edge 30. In the embodiment shown the fasteners 50 are staples or eyes/rings. However any conventional mechanical faster which is capable of linking the end-edges together can be used instead, such as lacing through the eyelets 51 or hinged clips.

The apertures comprise eyelet rings 51 to provide some rigidity to the apertures and prevent wear.

Although the figure shows four fasteners 50, any number of a fasteners may be present, i.e. typically greater than four. The invention can thus be used to provide reinforcement when mechanical fasteners are used at the interface rather than a bonded/spliced interface. In this example the interface 12 is wider than the seam of the spliced interface. In some examples, the fibre section 40 could be continuous across the interface 12, i.e. between the mechanical fasteners 50. In such an example, the fibre section 40 may have the cover layer(s) described above.

The belt may comprise a plurality of eyelets which may be aligned along the width of the belt (i.e. parallel to the width edge). The engagement means may further comprise a mechanical fastener linking the first end to the second end. The fastener may be a clip, staple, or lacing. The fastener may be selectively removable such that it can be replaced when damaged.

The approach used for mechanical joint reinforcement may be used in other belt types (namely Timing Belts and Monolithic/Homogenous Belts).

The position of the interface 12 may be formed to be different on the first major surface of the belt (i.e. the top surface in use) than the second major surface of the belt (i.e. the bottom surface in use). For example, the first and second end-edges may have a sloped edge for complementary engagement i.e., a slope/diagonal like joint through the thickness of the material. If the first and second end-edges have been spliced, the fingers on the top surface may be a different length and/or width from the fingers on the bottom surface. For example, the first end may be comprised from several ply layers where the spliced fingers on the top layer are longer than the spliced fingers on the bottom layer. Alternatively, the spliced fingers of the first and second major surfaces may be the same length.

The fibre section (e.g., the body portion thereof) may extend a maximum distance of 100 cm from the interface in the direction of the first and/or second end-edge. The maximum distance may be less than 50 cm, or 25 cm, 20 cm, 15 cm, 10 cm or 5 cm. The maximum distance is dependent on the shape and position of the interface. Where the joint comprises spliced fingers, the interface will be zig-zagged shaped. The maximum distance may be defined between the tip/apex of a finger to the edge of the fibre section. The maximum distance may instead be defined as the distance from the free edge of the separated ply on a given end-edge (e.g., the edge of the end-edge), to the unseparated middle section.

The splice fingers/formations could be shapes other than triangular, for example, be castellated such as to have a toothed appearance. The fingers may be elongated such that they are configured to extend or be elongated in the longitudinal axis/direction of the belt compared to their width. Each end-edge may comprise four, five, six or more splice formations/fingers.

Other types of joints may be accommodated by the invention, such as a wedge splice.

### Test Results

Embodiments of the invention have undergone tensile tests and puncture tests to determine the relative strength of the reinforced interface.

Rectangular belt sections comprising a reinforced interface were prepared according to various different belt thicknesses and combinations of belt, adhesive and fibre section materials. The bets sections were attached to clamps of a tensile testing machine and tensioned at a constant speed of 100mm/min until they broke apart.

It was found that the reinforcement of the splice results in an improvement of the tensile strength relative to conventional spliced belts of between 13% and 84% in both the maximum force (N) and tensile strength (N/mm).

Mechanical joints using wire hooks akin to the embodiments described herein were also tested and showed an improvement of approximately 11% in tensile strength when comparing to conventional wire hook splicing technology. However this relatively small improvement can be attributed to the nature of the splice failure, which was observed to be mainly caused by the wire hooks opening apart rather than the belt breaking.

For puncture strength testing, a cylindrical flat punch with a diameter of 8 mm was employed. The load was applied at a constant speed of 5 mm/min at the middle point of a central finger of the splice until splicing failure. Puncture test of samples with splicing bonded by hot pressing were performed and the Maximum Force (N) and Compressive Stress (MPa) results were recorded.

In general, it was observed that the reinforcement of the splicing resulted in a significant enhancement of the load that the belts can tolerate before failure. The resulting splices are up to 4.8 times stronger than the sample with the conventional splicing technology.

Some of the reinforced splices are even stronger than the core of the standard unspliced belt sample (i.e. a body portion of the belt that comprises no joint). Particularly, the strongest reinforced splice according to the invention that was tested demonstrated maximum force and compressive stress values that were 64% higher than those for the unspliced body portion of the belt.

The fact that the reinforced joint can offer greater puncture resistance than the remainder of the belt is an unprecedented finding in the art and is particularly encouraging. In short, if the joint can be reinforced so as to become the strongest portion of the belt, this greatly reduces the likelihood of joint failure and increases the operational life expectancy of the belt. This means it becomes more likely that belts will wear out to achieve their maximum operational life rather an experiencing an earlier belt failure.

It is envisaged that the invention will predominantly be used to address the biggest source of belt waste, namely PVC (used in PVC and rubber belts). However, the invention may be used for thinner type belts, namely PU, Polyolefin, Cotton, Polyester, Polyamide and Silicone Belts.

1. A method of forming a joint in a belt having first and second end-edges to be joined, the method comprising:
providing a fibre section having first and second edges, the fibre section comprising aramid fibres;
arranging the first end-edge of the belt to at least partially overlap the first edge of the fibre section,
arranging the second end-edge of the belt to at least partially overlap the second edge of the fibre section; and
joining the first and second end-edges to the fibre section in said arrangement so as to form a joint interface between the first end-edge and the second end-edge, wherein the joint interface is reinforced by the aramid fibres.

2. A method of forming a joint according to claim 1, where the fibre section comprises a first major surface, where the first end-edge is joined to the first major surface.

3. A method of forming a joint according to claims 1 or 2, where the second end-edge is joined to the first major surface.

4. A method of forming a joint according to claims 2 or 3, where the fibre section comprises a second major surface, where the first end-edge is also joined to the second major surface.

5. A method of forming a joint according to claim 4, where the second end-edge of the belt is also joined to the second major surface.

6. A method of forming a joint according to any of the previous claims, where the belt comprises a plurality of plies, where the fibre section is inserted or arranged between the plies at the first end-edge of the belt.

7. A method of forming a joint according to claim 6, where the fibre section is inserted between plies at the second end-edge of the belt.

8. A method of forming a joint according to claims 6 or 7, where the plies are separated prior to inserting the fibre section, for example to a predetermined longitudinal distance from the first and/or second end-edge.

9. A method of forming a joint according to any of the previous claims, where the first and/or second end-edges are profiled to define splice formations.

10. A method of forming a joint according to claim 9, where the splice formations comprise fingers having a length of 50-150 mm or 90-100 mm.

11. A method of forming a joint according to any of the preceding claims, where the splice formations of the first end-edge are interposed between opposing splice formations of the second end-edge.

12. A method of forming a joint according to any of the previous claims where the first end-edge abuts or overlaps with the second end-edge when joined to the body portion.

13. A method of forming a joint according to any of the previous claims, where the fibre section comprises a fibre body portion which is coated in an adhesive.

14. A method of forming a joint according to claim 13, where the fibre section is treated once positioned on the belt to melt the adhesive, and thereby bond the first and second end-edges to the body portion.

15. A method of forming a joint according to claim 13 or 14, where the fibre section is cut from a larger fibre section.

16. A method of forming a joint according to any of claims 13-15, where the fibre body portion is comprised of woven fibres.

17. A method of forming a joint according to any preceding claim, where the fibre section comprises para-aramid fibres.

18. A method of forming a joint according to any of the previous claims, where fasteners are joined to the first and second end-edges, preferably hook-fasteners or clips, or staples, the fasteners spanning the joint interface.

19. A reinforced belt, comprising a belt body and a fibre section, where the fibre section comprises aramid fibres and is joined proximal to a first end edge of the belt body that forms an interface with an opposing second end edge of the belt body such that the belt body defines a closed loop, the fibre section having a discrete length in a longitudinal direction of the belt body such that it terminates on either side of the interface and the belt body extends in the longitudinal direction beyond the fibre section.

20. A reinforced belt according to claim 19, where the belt is a conveyor belt or timing belt.

21. A reinforced belt according to claims 19 or 20, where the belt body comprises a plurality of localised fibre reinforced joints at longitudinally spaced locations.

22. A reinforced belt according to claims 19-21, wherein the belt comprises a plurality of plies and the fibre section is located in-between adjacent plies.

23. A belt according to claims 18-21, where the belt is comprised from polyvinyl chloride (PVC) or polyurethane (PU).

24. A belt according to claims 18-21, where the fibre section is comprised of woven para-aramid fibres.

25. A fibre section sheet material for use for in forming a reinforced belt joint, the fibre section having a fibre composite layer comprising a textile having aramid fibres provided in an adhesive matrix; where the adhesive at least partially covers the aramid fibres and is cured or hardened to permit handling of the fibre section.

26. A fibre section according to claim 25, where fibres are raw loom state fibres, e.g. uncoated fibres, within the adhesive matrix.

27. A fibre section according to claims 25 or 26, the adhesive is recurable, optionally the adhesive comprises a thermoplastic.

28. A fibre section according to any of claim 25 to 27, the adhesive comprises a rubber

29. A fibre section according to any of claims 25-28, where the fibres are woven.

30. A fibre section according to any of claims 25-29, the textile having apertures therein to provide keying locations for penetration by a belt material in use.
